(19) United States
(12) Patent Application Publication
(10) Pub. No.: US 2012/0022877 A1
(43) Pub. Date: Jan. 26, 2012

(54) Dynamic Range Improvement Technique

(76) Inventor: Larry Joseph Kirn, Austin, TX (US)

(21) Appl. No.: 13/188,378

(22) Filed: Jul. 21, 2011

Related U.S. Application Data
(60) Provisional application No. 61/366,247, filed on Jul. 21, 2010.

(51) Int. Cl. G10L 21/00

(52) U.S. Cl. 704/500; 704/E19.001

(57) ABSTRACT

Apparatus and methods are disclosed for detecting and progressively attenuating specific frequencies prevalent in an audio signal. In contrast to conventional wide-band enhancement techniques over long time frames, narrow bandwidths and short attenuation times employed are commensurate with resonances and timing typical of speech. Apparent dynamic range is therefore increased through attenuation of longer-duration elements with declining informational contribution.

### REFERENCE TO RELATED APPLICATIONS

This application claims priority to U.S. Provisional Patent Application Ser. No. 61/366,247, filed Jul. 21, 2010, the entire content of which is incorporated herein by reference.

### FIELD OF THE INVENTION

This invention relates generally to audio devices, and particularly to apparatus and methods to improve intelligibility and/or perception of sound, such as speech.

### BACKGROUND OF THE INVENTION

Ability to understand speech is critical, particularly in the presence of high ambient noise, low transmission bandwidth, and/or hearing deficit. Almost all research in improving speech intelligibility to date has focused on improvements to the audio transmission channel and/or mitigating deleterious effects of external sound sources—competitive noises along the path between speaker and listener.

Technical limitations, notably in bandwidth available from analog filters, have largely constrained the majority of this research to manipulation of wide bandwidths only, with little attention paid to extremely narrow-bandwidth spectra. Although the unpredictable nature of many noise sources also encourages manipulation of broad spectral widths to maximize coverage over anticipated competitive noise sources; it has been shown repeatedly that masking from competitive noise is exacerbated by both spectral proximity to the desired signal and spectral density of the noise. Narrow-bandwidth noise near frequencies intended to be discerned therefore creates much more severe disruption than broadband competition spectrally removed from the desired signal.

Early speech research met severe technical limitations, notably the filters available to early hearing research had limited frequency discrimination. This limitation, in conjunction with limited ability of technologies in use to quickly discern specific spectral features in real time, enforced the use of relatively static filtering with broad bandwidths. This practice became codified into mainstream research as the relatively standardized tuning bands, each of which encompass no less than an octave, now seen in the field. Adoption of accepted broad spectral bands as common practice is slowly eroding, largely due to visibility of the fact that the masking capacity of competitive sound often is in inverse proportion to bandwidth. This could be seen as intuitive, considering energy density differential between a single frequency and broader-bandwidth noise, yet highly-specific spectral manipulation is not commonly seen in speech applications. Most current hearing enhancement devices manipulate spectral components no smaller than one-half octave.

Speech as it is commonly heard contains a preponderance of energy that imparts little language information. The energy integrals of specific speech elements are as well coming to be seen as disproportionate with the language information they impart. Energy of many speech elements, particularly some vowels, are augmented considerably by durations which in many cases extend far beyond that required for intelligibility.

It has been recognized for some time that both temporal and spectral proximity of competitive sound sources increase their potential to hide or mask perception of desired sound or speech. Resonant formant frequencies of many vowels are formed in many speakers very near critical frequencies necessary for understanding of other vowels, or consonants. Prolonged duration of these vowels, characterized by much higher energy integrals than critical low-energy short-duration speech elements at nearby frequencies, can therefore be seen as potential masking agents for some other critical lower-energy speech elements. Many consonants, typically at higher frequencies and shorter durations, fall into this disadvantaged category; yet serve to impart much more language information than the speech energy potentially masking them. Diphthongs are another example wherein the first vowel may easily overpower the second. These critical elements may then be effectively masked by other longer-duration components of the speech itself, even before competition from external sources takes a toll on intelligibility.

Although static passband filtering to accentuate typical frequency bands necessary for speech is in common practice, very little work has been done to isolate and mitigate these internal elements within speech itself which serve to degrade intelligibility. Being internal to the speaker, these potential masking sources are not deterred by noise reduction techniques which target noise sources external to both the speaker and listener. Highly pronounced head resonances and strong vowels are extremely individuated from speaker to speaker, very unpredictable, and highly frequency-specific; so are not easily addressed by invariant wide-bandwidth filtering commonly used. In contrast to broadband approaches, filter bandwidths of 1/12 octave or less are necessary to effectively isolate these elements. Even with the capacity to selectively remove these components in an agile fashion, an adaptive targeting method is necessary to address the mercurial nature of the masking sources.

In this context of broad spectral widths, concentration on long time frames has as well been the pervasive direction in noise mitigation. The repetitive nature of many noise sources, especially with tenuously-known characteristics, has also encouraged longer time frames for detection and dynamic reduction of noises competitive to speech. Several studies using brief noises to discern masking of earlier speech, as compared to masking of later speech (backward versus forward masking) have however shown the impact of even brief competitive noise sources.

The temporal aspect of potential internal masking sources may be illustrated by a technique in common use among pipe organists. Unlike pianos and other instruments with amplitude control through force or velocity, amplitude of a pipe organ may only be controlled slowly. Key presses are digital events with no coupling to output amplitude. Apparent dynamic range is therefore much more limited than other more easily articulated instruments. To accommodate this technical deficiency, organists routinely decrease the duration of notes played immediately before an apparent immediate increase in volume is desired. The relative silence so injected increases the apparent dynamic range, creating a perception of accentuation following the silence. It is therefore postulated that elements within speech with durations past that necessary for intelligibility actually degrade the overall perceived dynamic range, hence intelligibility.

Noise reduction to improve speech intelligibility or even musical perception through external noise reduction currently principally operates on wide spectral ranges with relatively slow dynamic behavior. Both broad spectral and temporal manipulation is inconsistent with improvement to perceived instantaneous dynamic range. A need exists for a method whereby perceived dynamic range of an audio signal is improved through identification and reduction of internal elements with disproportionately high energy to informational contribution.

### SUMMARY OF THE INVENTION

The present invention resides in apparatus and methods for detection and progressive selective attenuation in time of narrow spectral components in an audio stream with higher prevalence over other frequencies within that stream.

### BRIEF DESCRIPTION OF THE DRAWINGS

FIG. 1 shows a block signal processing diagram of an exemplary embodiment of the present invention.

FIG. 2 shows use of the present invention within a hearing aid device.

FIG. 3 shows relative spectral distribution of input to and resultant outputs in time from an embodiment of the present invention as an extended vowel such as ‘aa’ is presented to the invention.

### DETAILED DESCRIPTION OF THE INVENTION

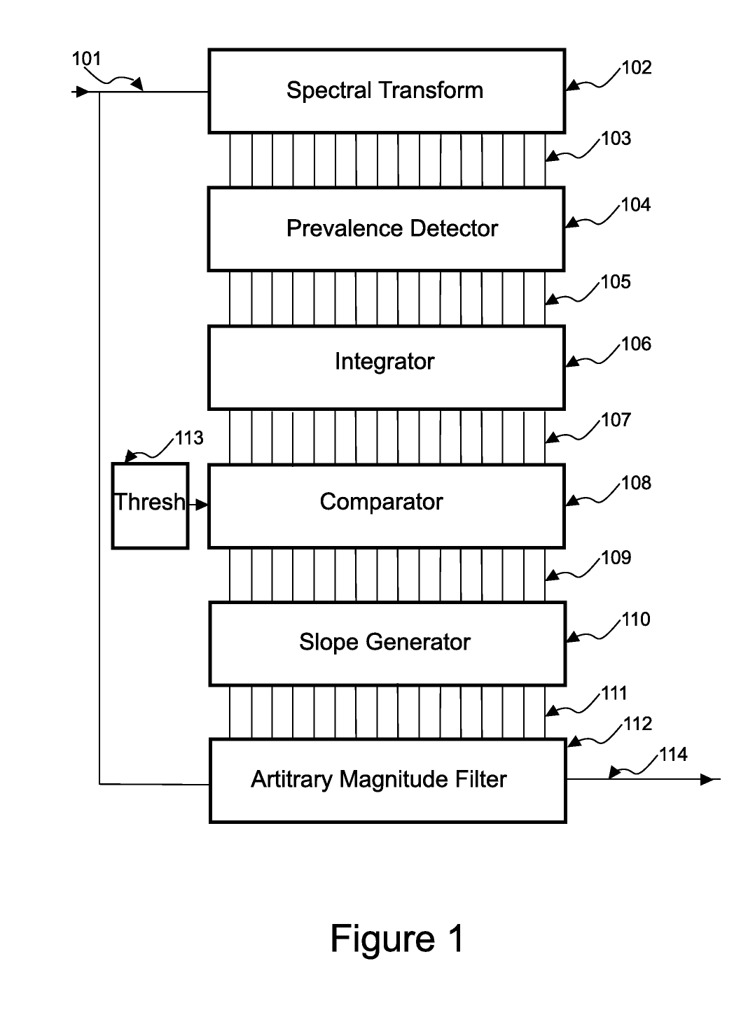

Referring now to FIG. 1, incoming Audio Stream 101 is applied as input to both Spectral Transform 102 and Arbitrary Magnitude Filter 112. Spectral Transform 102 converts the time-domain Stream 101 into many frequency-domain Amplitude Indications 103, as is know to the art. Spectral Transform 102 may be embodied as a chirp, or wavelet, transform; and may be applied to a defined spectral subset of the incoming Stream 101.

Amplitude Indications 103 are applied as input to Prevalence Detector 104, which converts received amplitude information into digital Prevalence Indications 105, denoting any of said Amplitude Indications 103 which are prevalent in Stream 101. Prevalence Detector 104 may employ frequency weighting, such as that approximating average human hearing.

Prevalence Indications 105 are provided as input to Integrator 106, which provide Prevalence Integrals 107. Prevalence Integrals 107 individually increase in time for any incoming Prevalence Indicator 105 which is active, but immediately reset to zero as the input Prevalence Indicator becomes inactive.

Prevalence Integrals 107 are applied as input to Comparator 108, which compares each Integral so received with a value derived from Threshold 113. Note that the output of Threshold 113 may be either static or dynamic, and that individual comparison values for each Prevalence Integral 107 may be individually weighted. Results from Comparator 108 are output as Duration Indicators 109. Note that the reset capability of Integrator 106 cause any of Duration Indicators 109 to immediately become inactive when its respective member of Prevalence Indicators 105 becomes inactive, but to become active only after its respective member of Prevalence Integral 107 exceeds its respective threshold derived from Threshold 113.

Duration Indicators 109 are supplied as input to Slope Generator 110, which converts digital inputs into smoothly increasing values, output as Attenuation Controls 111. Reset capability is assumed for Slope Generator 110; an active input results in increasing output value, but an inactive input immediately resets the respective member of Attenuation Controls 111 to zero. Although logarithmic increase is assumed for use with audio signals, specific slopes in time output as Attenuation Controls 111 may be of any function, and may as well be weighted in time or value by frequency. Increase of any member of Attenuation Controls 111 may be arrested at predetermined or calculated values.

Attenuation Controls 111 are supplied as attenuation inputs to Arbitrary Magnitude Filter 112, which attenuates specific frequencies of incoming Stream 101 by the amount specified by its respective member of Attenuation Controls 111. The output of Filter 112 is supplied as Output Stream 114, for continued use, such as amplification to loudspeakers.

Depiction of multiple streams corresponding to multiple spectral categorizations within Signals 103, 105, 107, 109, and 111, as practiced in the art, illustrates parallel operation of the current invention upon a multiplicity of prevalent frequencies which may or may not share temporal correlation. The limited number of categorizations so shown is for simplicity only and does not imply limitation to wide spectral bands. Although current technology and the diagram of FIG. 1 favor implementation of the current invention using digital techniques, partial or complete implementation using analog techniques is as well anticipated.

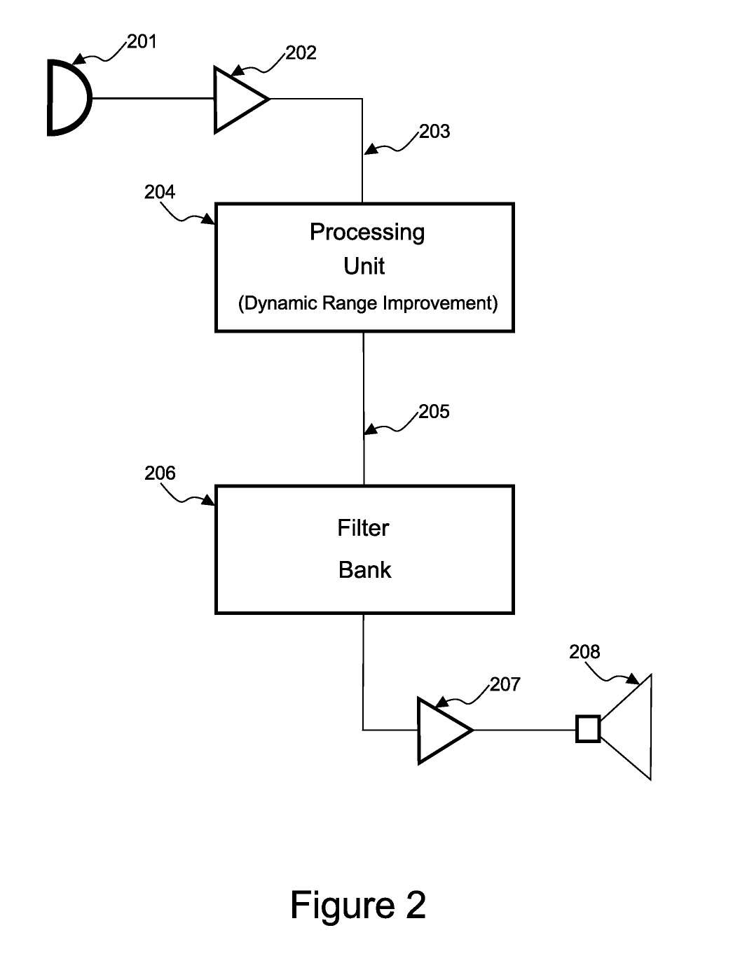

Referring now to FIG. 2, Microphone 201 converts physical audio input into an electrical which is input to Amplifier/Converter 202. Amplifier/Converter 202 presents a compatible input Signal 203 to Processing Unit 204, which performs requisite activities of the present invention, such as those shown in FIG. 1, on the incoming signal. The output Signal 205 of Processing Unit 204 is supplied to Filter Bank 206, which modifies the frequency response of the unit to address specific needs of the user. The output of Filter Bank 206 then drives Converter/Amplifier 207, which in turn drives Speaker 208. It is assumed that the device depicted in FIG. 2 is miniaturized and utilizes digital signal processing techniques, as is practiced in the art.

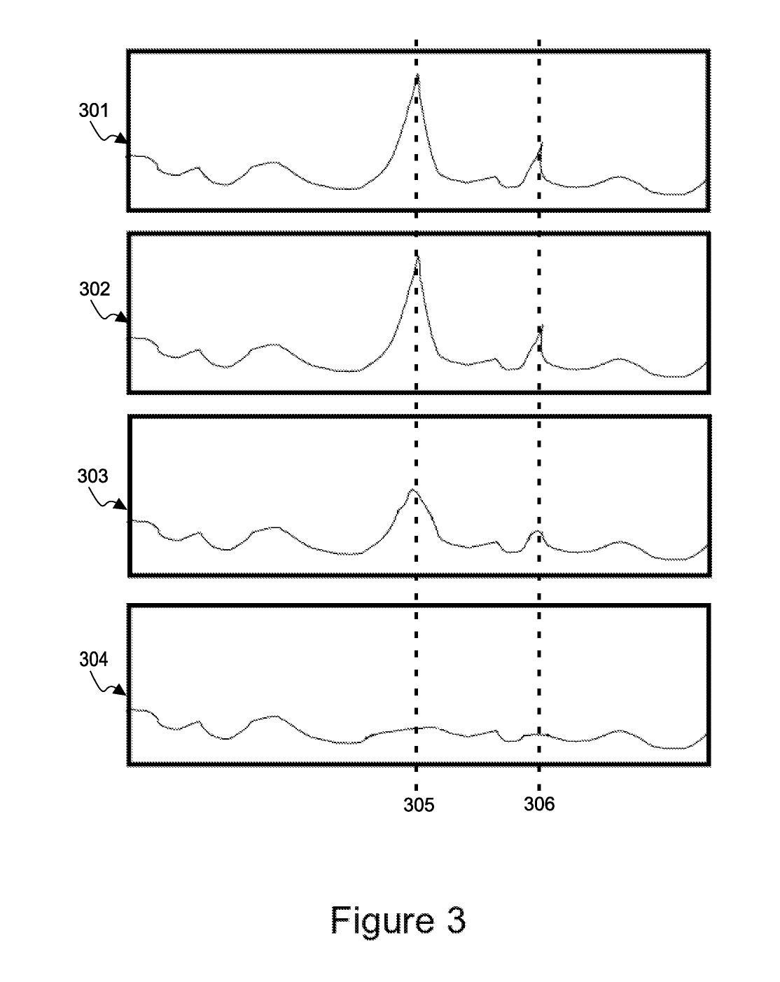

Referring now to FIG. 3, relative amplitude on the Y axis is shown against relative frequency on the X axis in four Spectral Distributions. Spectral Distribution 301 shows content of a prolonged input signal to the current invention, such as the vowel ‘aa’, as may occur as Signal 203 of FIG. 2 in expected operation. Spectral Distribution 302, 303, and 304 show content of the resultant output signal derived from the current invention, such as Signal 205 of FIG. 2, at 2 milliseconds, 25 milliseconds, and 50 milliseconds, respectively, after initiation of said prolonged vowel.

At Frequency Markers 305 and 306, amplitude peaks, presumably from nasal resonance and/or vowel formants, can be seen in input Distribution 301 and initial output Distribution 302. It therefore can be seen that minimal spectral manipulation is effected by the current invention immediately after receipt of a new spectral content. Amplitude peaks at Markers 305 and 306 can be seen to be lower in Distribution 303, and effectively non-existant in Distribution 304. It can thus be seen that amplitude peaks at the specific frequencies of Markers 305 and 306 are progressively attenuated as duration of the input vowel continues. It can as well be seen in the broader spectral distributions common to Distributions 301, 302, 303, and 304 that specific frequencies, or narrow-band components, only are affected by the current invention, without disruption of overall frequency response.

Functionally, the previous disclosure shows that specific frequencies of the incoming stream which are found to be prevalent within a deterministic period of time are progressively attenuated, possibly to deterministic levels.

Integration and attenuation slope times are assumed to be consistent with the timing of normal speech, and may be adaptive to specific speakers or circumstances. Speed of control may be adequate to provide activity on even quickly-spoken diphthongs. Frequency weighting to address factors such as average hearing frequency response or masking potential may be employed, so are anticipated within the scope of the present invention.

I claim:

1. A system for improving apparent dynamic range of an audio signal comprising:
means to receive an audio signal;
means to detect prevalence in time of specific frequencies of said audio signal;
means to progressively and selectively attenuate content within said audio signal at said specific frequencies; and
means to output said audio signal so attenuated.

2. The system of claim 1 wherein frequency discrimination of said specific frequencies exceeds twelve parts per octave.

3. The system of claim 1 wherein analog circuitry is employed.

4. The system of claim 1 wherein digital signal processing is employed.

5. The system of claim 1 when incorporated in a hearing aid device.

6. A method for improving apparent dynamic range of an audio signal comprising the steps of:
receiving an audio signal;
detecting prevalence in time of specific frequencies of said audio signal;
progressively and selectively attenuating content within said audio signal at said specific frequencies; and
outputting said audio signal so attenuated.

7. The method of claim 6 further comprising operational adaptation to specific speakers or circumstances.

8. The method of claim 6 wherein a chirp or wavelet transform is employed.

9. The method of claim 6 wherein cessation of content at any specific frequency immediately terminates attenuation at said specific frequency.

10. The method of claim 6 further comprising compensation to address average hearing frequency response.

11. The method of claim 6 wherein progressive selective attenuation occurs within individual syllables of speech.
